(19) United States
(12) Patent Application Publication
(10) Pub. No.: US 2010/0037064 A1
(43) Pub. Date: Feb. 11, 2010

(54) Method of encryption and decryption and a keyboard apparatus integrated with functions of memory card reader and fingerprint encryption/decryption

(76) Inventor: Allen Ku, Walnut, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,243

(22) Filed: Aug. 6, 2008

(51) Int. Cl. H04L 9/06

(52) U.S. Cl. 713/186

(57) ABSTRACT

A method of encryption and decryption and a keyboard apparatus integrated with a memory card reader and an encryption/decryption scheme using fingerprints is disclosed. The invention integrates a memory card reader and a fingerprint scan module into a keyboard apparatus. The memory card reader and fingerprint scan module are jointly using the power supply and data transmission port. Therefore, the keyboard apparatus uses the memory card reader to function data transferring, and the fingerprint scan module is used to retrieve a fingerprint of the user, which is used to encrypt or decrypt the data in the memory card by the keyboard's driver. Thereby, in the preferred embodiment, the biometric characteristic is applied to encrypt/decrypt the data in the computer system or the data in the memory card by a program installed in the computer system. The multi-functional keyboard is achieved.

### BACKGROUND OF THE INVENTION

1. Field of the Invention

The present invention is related to a method of encryption and decryption and a keyboard apparatus which integrates a memory card reader and a fingerprint encryption/decryption function, more particularly to provide a simplified data encryption or decryption through the integration of memory card reader and the fingerprint scan module with the keyboard apparatus.

2. Description of Related Art

The keyboard is the most often used input device for a computer. With the widespread development of computer peripherals, peripheral devices intended to be connected to a computer are getting more. This may cause a lot of cables cluttering the desk since each of the devices has its own connections and the power lines.

Reference is made to FIG. 1, which shows a schematic diagram of the connection regarding a computer and the peripherals. The computer 10 has at least three connected input devices such as a keyboard 12, a computer mouse 18, and a card reader 16 for reading a memory card. The card reader 16 often connects to the computer 10 via a universal serial bus (USB). Additionally, a fingerprint scanner 14 is connected, used for scanning the user's fingerprints and authenticating the user. For example, the user cannot login the computer 10 until he passes the fingerprint authentication. Moreover, the fingerprint scanner can also encrypt data in the computer 10.

The above-mentioned card reader 16 has its own connection to the computer 10, and enables the user to read or write to a memory card. The fingerprint scanner 14 also has its own line connected to the computer 10, and further needs a proprietary software application installed in the computer 10 for retrieving the fingerprint image. The biometric features retrieved from the fingerprints can be used for other applications such as the operating system authentication or data encryption/decryption.

Some current computer systems, especially notebook computers, have installed fingerprint scanners that are integrated into the structure of the computer systems in order to enhance the security of the systems. Still, the fingerprint scanner has an inside proprietary connection with the computer system.

### SUMMARY OF THE INVENTION

A method of encryption and decryption and a keyboard apparatus integrated with the functions of memory card reader and fingerprint encryption and decryption of the present invention are provided in view of some conventional arts. The conventional arts provide a scheme using a computer system integrated with some peripherals such as the card reader and the fingerprint scanner, and further incorporate the relevant software and hardware to reach some functions. The provided keyboard apparatus particularly integrates the circuits of a card access module and a fingerprint scan module. Those peripherals jointly use the communication port and the power supply module of the original keyboard, therefore the claimed keyboard apparatus processes the encryption and decryption on the data in a memory card conveniently.

The preferred embodiment of the keyboard apparatus with function of fingerprint encryption/decryption of the invention includes a keyboard controller that is used to process the input and output signals of the keyboard, and to convert the scan coded received from a keyboard scan circuit and send them out. The keyboard apparatus further includes a fingerprint scan module that is used to transmit fingerprint scan signals to the computer system through the keyboard controller. More particularly, the keyboard apparatus outputs the signals generated by the keyboard to the computer system via a communication unit and communication port. Those signals are generated by the above-mentioned fingerprint scan module and a memory card access module.

The preferred embodiment of the method for encrypting and decrypting data by employing fingerprint characteristics provided by the keyboard apparatus has a first step of enabling a driving and encryption/decryption program used to drive the keyboard apparatus connected with a computer system. Next, a connection between a fingerprint scan module and a memory access module is established after booting up the computer system. Next, the driving and encryption/decryption program receives the signals generated from the memory card access module as a memory card is inserted. After that, the method goes to request scanning fingerprints that is used to decrypt the data when the driving and encryption/decryption program determines that the data has been encrypted; or request scanning fingerprints that is used to encrypt the data when the driving and encryption/decryption program determines that the data has not been encrypted. At last, a biometric characteristic value is generated after translating the signals, and used to perform encryption or decryption on the data.

Moreover, the fingerprint scan module and the memory card access module jointly share the power for the keyboard apparatus, and jointly use the communication port connected to the computer system. The main object of the present invention is to encrypt or decrypt the data in the memory card by employing the biometric characteristic value retrieved from the fingerprint scan signals through a keyboard driver.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a conventional example of the connection between the card reader and the finger scanner;

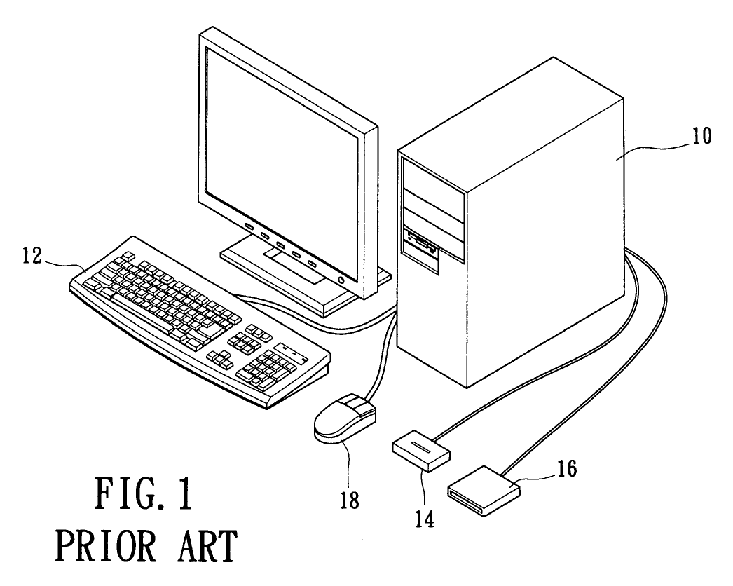

FIG. 2 shows a schematic diagram of a keyboard apparatus having the cared reader and the function of fingerprint encryption and decryption of the present invention;

FIG. 3 shows a block diagram of the circuit of the claimed keyboard apparatus;

FIG. 4 shows a flow chart illustrating the method of encryption or decryption of the claimed keyboard apparatus.

### DETAILED DESCRIPTION OF THE PREFERRED EMBODIMENTS

The present invention is illustrated with a preferred embodiment and attached drawings. However, the invention is not intended to be limited thereby.

The present invention relates to a keyboard apparatus with the function of fingerprint encryption/decryption on the data in a memory card. The keyboard apparatus integrates a memory card access module and a fingerprint scan module, in order to integrate the functionalities provided by the two modules.

It is different from the conventional memory card reader or fingerprint scan device which adopts its proprietary driver and signal cable, the memory card access module and the fingerprint scan module installed in the keyboard apparatus jointly share the power and communication port. Therefore, the users can easily access the memory card by this claimed keyboard apparatus, and send data read from a memory card to a computer system or write data to the memory card. More particularly, the user's own biometric characteristic value can be obtained from his fingerprints, which is retrieved by the fingerprint scan module, by a driver for encrypting or decrypting the data in the memory card.

The mentioned power supplied for the keyboard apparatus can be obtained through the communication port connected to the computer system. For example, a universal serial bus (USB) is generally used to supply power from the computer system. Alternatively the power can be supplied by batteries stored inside the keyboard apparatus. The modules integrated into the keyboard apparatus of the present invention can accordingly share the power supply in order to reduce the amount of cables connected to the computer system and further decrease the number of power management circuits used for the modules.

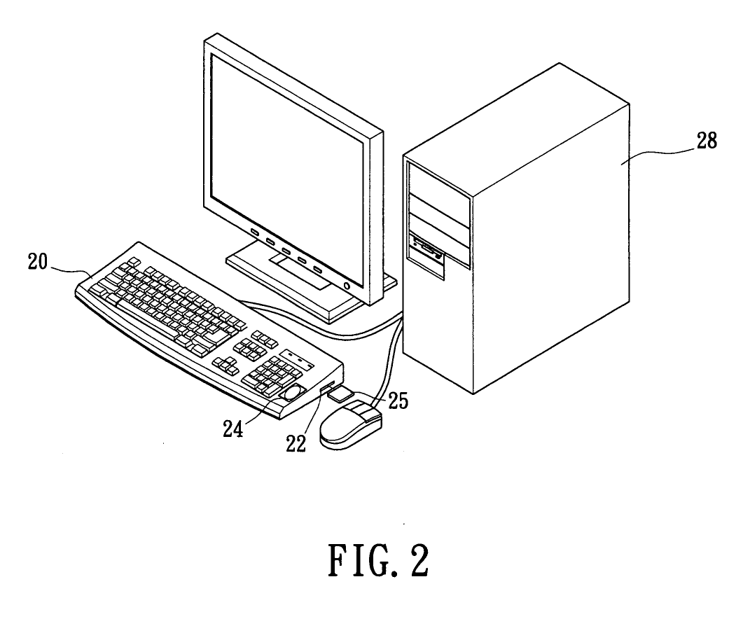

According to the preferred embodiment, the program installed in the computer system is used to apply the biometric characteristic value to encrypt or decrypt the data in the computer system or the data in the memory card. Reference is made to FIG. 2 that shows the embodiment of the claimed keyboard apparatus. The keyboard apparatus 20 is connected to a computer system 28. The computer system 28 is not limited to a desktop computer shown in the diagram, but can be a notebook computer, a personal digital assistant (PDA) or a similar device for organizing data. A fingerprint scanner 24 and a memory card socket 22 are shown on the keyboard apparatus 20.

The fingerprint scanner 24 is used to retrieve the user's fingerprints, and generate the fingerprint scan signals through the fingerprint scan module of the keyboard apparatus 20. After that, the signals are transmitted from the keyboard apparatus 20 to the computer system 28 via wired or wireless communication. Similarly, as the memory card 25 is inserted into the card reader socket 22, the memory card access module is activated to transmit the data from the keyboard apparatus 20 to the computer system 28 by means of the communication therebetween.

Since the claimed keyboard apparatus integrates the fingerprint scanner and memory card reader, the relevant computer system needs a driver to incorporate the driving programs for the memory card access module and the fingerprint scan module. Further, the driver combines the functionalities provided by the two modules. The driver for the keyboard apparatus 20 can be used to drive the data in the memory card 25 to transmitted to the computer system 28 via the communication port. The driver also drives the fingerprint scan signals to be generated by the fingerprint scanner 24, and transmitted to the computer system 28.

Since the driver integrates the two modules, the fingerprint scan module and the memory card access module can operate and signal individually, and the driver can also drive the biometric characteristic value to encrypt or decrypt the data in the memory card.

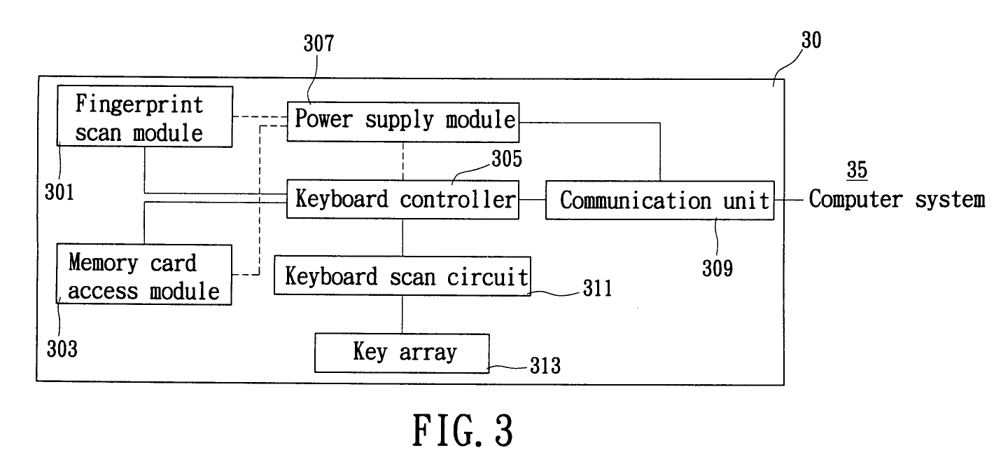

Reference is made to FIG. 3 showing a block diagram of the circuit of the keyboard apparatus. According to the preferred embodiment, the circuits of the memory card access module and fingerprint scan module are integrated, so that the two modules share the communication port and power. In particular, the data in the memory card can be encrypted or decrypted conveniently.

The keyboard apparatus integrated with the functions of memory card reader and the fingerprint encryption and decryption at least has a fingerprint scan module 301, memory card access module 303, keyboard controller 305, power supply module 307, communication unit 309, keyboard scan circuit 311 and a key array 313. Both the mentioned fingerprint scan module 301 and memory card access module 303 are electrically connected with the keyboard controller 305 and the power supply module 307 of the keyboard apparatus 30. The power for the keyboard apparatus 30 is jointly used by the memory card access module 303 and the fingerprint scan module 301. The power is supplied by the computer system 35, or by the batteries in the keyboard. Through the keyboard controller 305, the communication unit 309 using the same way to connect with the computer system 35 is shared with the two modules.

The mentioned keyboard controller 305 is mainly used for processing the input/output signals of the keyboard apparatus 30—including the original function of converting the scan code that is retrieved from the key array 303 through the keyboard scan circuit 311. After converting the scan code to a well-known key code, the key code is sent to the computer system 35 through the communication unit 309 that is connected to the keyboard controller 305. According to the embodiment of the invention, the keyboard controller 305 can handle the signals from the fingerprint scan module 301 and the memory card access module 303 at one time.

The fingerprint scan module 301 is electrically connected to the keyboard controller 305, and used to generate fingerprint scan signals after receiving the fingerprints. The fingerprint scan signals are further sent to the computer system 35 through the keyboard controller 305. The driver is used to drive the keyboard apparatus 30 and used to process the signals—including retrieving the biometric characteristic value from the fingerprint scan signals, and the biometric characteristic value is used to encrypt or decrypt data.

The memory card access module is also electrically connected to the keyboard controller 305, thereby the data in the memory card can be sent to the computer system 35 through the keyboard controller 305. Then the driver for the keyboard apparatus 30 takes over the data and save them to the storage medium of the computer system or send them back to memory card.

After the integration of the modules, the driver can encrypt or decrypt the data in the memory card by employing the biometric characteristic value retrieved from the fingerprint scan signals.

The embodiment described in FIG. 3 further has a power supply module 307. The power supply module 307 electrically connects to the keyboard controller 305. The power supply module 307 used to manage the supplied power of the keyboard apparatus 30—including the power supplied for the fingerprint scan module 301 and the memory card access module 303.

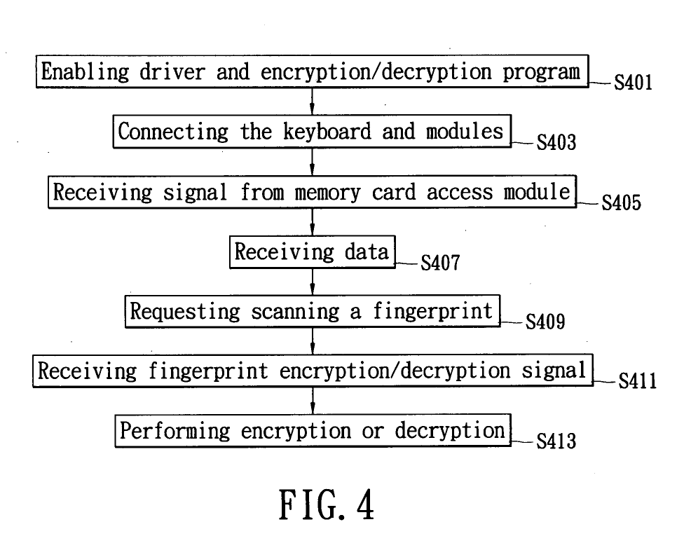

FIG. 4 shows an encryption/decryption flow chart applied to the keyboard apparatus. The preferred embodiment of the present invention integrates the drivers for the fingerprint scan module and the memory card access module into a single driver for the keyboard apparatus. This driver can be used to encrypt or decrypt the data by employing fingerprint characteristics. The procedure of encryption or decryption includes a first step S401 of enabling the driving and encryption/decryption program. This program is used to drive the claimed keyboard apparatus and establish a connection between the modules after booting up the computer system. Such as the step S403, the keyboard apparatus, fingerprint scan module and the memory card access module are connected.

Next, the driver receives the signal generated from the memory card access module as the memory card is inserted (step S405). The memory card is accessed, and the inside data will be stored in the computer system as receiving the data (step S407). When the driver determines that the data has been encrypted by a fingerprint, a relevant program will be launched to request the user to scan fingerprints (step S409). Next, the program receives the signals from the fingerprint scan module in step S411. After that, a biometric characteristic value is generated after translation and used to obtain the original data by performing decryption (step S413).

Otherwise, the above steps 409 through 413 are used to encrypt the data which is not encrypted by converting the biometric characteristic value.

The mentioned encryption/decryption procedure can be performed in batch processing through the driver installed in the computer system. If the data in the memory card is determined not yet encrypted, a fingerprint scan request will be launched in the meantime. The scanned fingerprint is demanded to encrypt the data. If the data in the memory card is determined already being encrypted, a request of scanning fingerprints will be demanded to decrypt the data.

In summation of above description, the present invention relates to a keyboard apparatus that integrates with the functions provided by a memory card reader and fingerprint encryption/decryption. The integrated fingerprint scan module and memory card access module can operate individually, and also process encryption or decryption of data directly in the memory card through the driver.

While the invention has been described by means of a specification with accompanying drawings of specific embodiments, numerous modifications and variations could be made thereto by those skilled in the art without departing from the scope and spirit of the invention set forth in the claims.

What is claimed is:

1. A keyboard apparatus integrated with a memory card reader and a function of fingerprint encryption and decryption, comprising:
a keyboard driver;
a keyboard controller used to process the input and output signals therein, and to convert the key codes received from a keyboard scan circuit and send them out;
a communication unit electrically connected with the keyboard controller, used to output the signals generated by the keyboard apparatus to a computer system through a communication port;
a fingerprint scan module electrically connected with the keyboard controller, used to transmit fingerprint scan signals to the computer system through the keyboard controller; and
a memory card access module electrically connected with the keyboard controller, used to transmit the data of a memory card to the computer system through the keyboard controller;
wherein the fingerprint scan module and the memory card access module jointly use the power supplied for the keyboard apparatus and the communication port to the computer system, whereby a biometric characteristic value of the fingerprint scan signals is used to encrypt or decrypt the data of the memory card by the keyboard driver.

2. The keyboard apparatus of claim 1, wherein the keyboard apparatus further comprises a power supply module electrically connected with the keyboard controller, used to manage the power supplied to the keyboard apparatus.

3. The keyboard apparatus of claim 2, wherein the power supply module is further electrically connected with the fingerprint scan module and the memory card access module.

4. The keyboard apparatus of claim 1, wherein the keyboard driver includes a card driver for the memory card access module and another driver for the fingerprint scan module.

5. The keyboard apparatus of claim 1, wherein the communication unit connects with the computer system via wired or wireless connection.

6. A method for encrypting and decrypting data by employing fingerprint characteristics provided by the keyboard apparatus according to claim 1, the method comprising:
enabling a driving and encryption/decryption program used to drive the keyboard apparatus connected with a computer system;
establishing a connection between a fingerprint scan module and a memory access module after booting up the computer system;
the driving and encryption/decryption program receiving the signals generated from the memory card access module as a memory card is inserted;
requesting scanning a fingerprint that is used to decrypt the data on the memory card when the driving and encryption/decryption program determines that the data has been encrypted; or requesting scanning a fingerprint that is used to encrypt the data when the driving and encryption/decryption program determines that the data has not been encrypted;
the program receiving the signals from the fingerprint scan module;
generating a biometric characteristic value after translating the signals; and
performing encryption or decryption on the data by employing the biometric characteristic value.

7. The method of claim 6, wherein the driving and encryption/decryption program integrates the drivers for the fingerprint scan module and the memory card access module.

8. The method of claim 6, wherein the steps of the method of encryption and decryption are performed by batch processing through the driving and encryption/decryption program.
